(19) United States
(12) Patent Application Publication
(10) Pub. No.: US 2009/0296313 A1
(43) Pub. Date: Dec. 3, 2009

(54) CAPACITOR STRUCTURE AND METAL LAYER LAYOUT THEREOF

(76) Inventors: Chih-Jung Chiu, Pingtung County (TW); Wen-Lin Chen, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 12/128,635

(22) Filed: May 29, 2008

(51) Int. Cl. H01G 4/06

(52) U.S. Cl. 361/311

(57) ABSTRACT

A capacitor structure includes: a first metal layer including: a first frame structure including a first main frame and at least a first frame strip coupled to the first main frame for separating the first main frame to a plurality of first frame sections; and a plurality of first strips, each of the plurality of first strips positioned and isolated in one of the plurality of first frame sections; a second metal layer including: a second frame structure including a second main frame and at least a second frame strip coupled to the second main frame for separating the second main frame to a plurality of second frame sections; and a plurality of second strips, each of the plurality of second strips positioned and isolated in one of the plurality of second frame sections; and a dielectric layer, formed between the first metal layer and the second metal layer.

### BACKGROUND

The present invention relates to a capacitor structure and a metal layer layout thereof, and more particularly, to a metal-oxide-metal (MOM) type capacitor structure and a metal layer layout thereof.

Capacitors are critical components in the integrated circuit devices of today. Large value capacitors are useful in analog circuits or radio frequency (RF) circuits such as those designed for filtering or signal processing. Due to trends toward higher levels of integration, it is desirable to integrate large value capacitors onto integrated circuit devices, and various types of integrated capacitors have been devised. For example, metal-oxide-metal (MOM) capacitors have been increasing in popularity because their minimal capacitive loss to the substrate results in a high-quality capacitor.

Applications of interdigitated metal capacitors have already been disclosed and discussed in various literature, such as U.S. Pat. No. 4,409,608, U.S. Pat. No. 5,208,725, U.S. Pat. No. 5,583,359, U.S. Pat. No. 5,939,766, U.S. Pat. No. 6,297,524, U.S. Pat. No. 6,383,858, U.S. Pat. No. 6,410,954, U.S. Pat. No. 6,600,209, U.S. Pat. No. 6,819,542, etc., whose contents are incorporated herein by reference.

In the U.S. Pat. No. 6,819,542, an interdigitated capacitor structure with a plurality of metal layers is disclosed, wherein the interdigitated capacitor structure includes at least a plurality of odd layers, a plurality of even layers, and a plurality of dielectric layers. The plurality of odd layers and the plurality of even layers make up a first electrode and a second electrode, respectively. The first electrode in the plurality of odd layers is coupled to the first electrode in the plurality of even layers through a first bus. Likewise, the second electrode in the plurality of odd layers is coupled to the second electrode in the plurality of even layers through a second bus.

In U.S. Pat. No. 6,819,542 (hereinafter “the '542 Patent”), the interdigitated capacitor structure with a plurality of metal layers is defined. Please refer to FIG. 1 and FIG. 2 at the same time. FIG. 1 is a diagram of an odd layer 10 of the interdigitated capacitor structure as shown in FIG. 5B of the '542 Patent. FIG. 2 is a diagram of an even layer 20 of the interdigitated capacitor structure as shown in FIG. 6B of the '542 Patent.

Please first refer to FIG. 1. The odd layer 10 includes a first electrode 11 and a second electrode 15. The first electrode 11 includes a first section 12, and a plurality of second sections 13 arranged in parallel. The first section 12 includes a first portion 12A and a second portion 12B. The first portion 12A and the second portion 12B respectively constitute the two legs of the L-shaped first section 12. The plurality of parallel-arranged second sections 13 join the first portion 12A of the first section 12, and are separated from one another by a predetermined distance. The second electrode 15 includes a first section 16, and a plurality of second sections 17 arranged in parallel. The first section 16 includes a first portion 16A and a second portion 16B. The first portion 16A and the second portion 16B respectively constitute the two legs of the L-shaped first section 16. The plurality of parallel-arranged second sections 17 join the first portion 16A of the first section 16, and are separated from one another by a predetermined distance. The plurality of second sections 13 of the first electrode 11 and the plurality of second sections 17 of the second electrode 15 are interdigitated in parallel.

Please now refer to FIG. 2. The even layer 20 includes a first electrode 21 and a second electrode 25. The first electrode 21 includes a first section 22, and a plurality of second sections 23 arranged in parallel. The first section 22 includes a first portion 22A and a second portion 22B. The first portion 22A and the second portion 22B respectively constitute the two legs of the L-shaped first section 22. The plurality of parallel-arranged second sections 23 join the first portion 22A of the first section 22, and are separated from one another by a predetermined distance. The second electrode 25 includes a first section 26, and a plurality of second sections 27 arranged in parallel. The first section 26 includes a first portion 26A and a second portion 26B. The first portion 26A and the second portion 26B respectively constitute the two legs of the L-shaped first section 26. The plurality of parallel-arranged second sections 27 join the first portion 26A of the first section 26, and are separated from one another by a predetermined distance. The plurality of second sections 23 of the first electrode 21 and the plurality of second sections 27 of the second electrode 25 are interdigitated in parallel. The second section 13 of the first electrode 11 in FIG. 1 is perpendicular to the second section 23 of the first electrode 21 in FIG. 2.

However, although the electrical connection between the part of an electrode in the odd layer and the part of the same electrode in the even layer is formed with the via plugs in the interdigitated capacitor structure with a plurality of metal layers in the U.S. Pat. No. 6,819,542, the locating positions of the via plugs are limited to the periphery of electrodes, and this condition results in a smaller unit capacitance for the interdigitated capacitor structure in the U.S. Pat. No. 6,819,542.

### SUMMARY OF THE INVENTION

It is therefore one of the objectives of the present invention to provide a capacitor structure with better capacitance characteristics and a higher unit capacitance.

According to an embodiment of the present invention, a capacitor structure is further disclosed. The capacitor structure includes a first metal layer, a second metal layer, and a dielectric layer, wherein the first metal layer includes a first frame structure and a first strip positioned and isolated in the first frame structure, and the second metal layer includes a second frame structure and a second strip positioned and isolated in the second frame structure, and the dielectric layer is formed between the first metal layer and the second metal layer.

According to an embodiment of the present invention, a metal layer layout for a capacitor structure is further disclosed. The metal layer layout includes a metal layer, and the metal layer includes a frame structure and a strip positioned and isolated in the frame structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified diagram of an odd layer of a multilevel interdigitated capacitor structure according to the prior art.

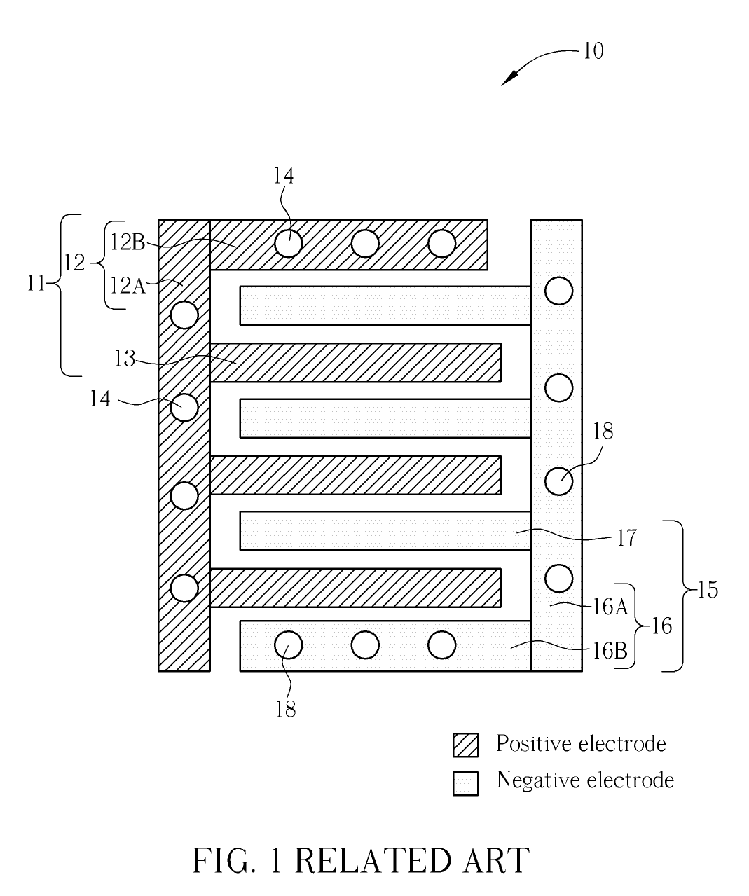

FIG. 2 is a simplified diagram of an even layer of a multilevel interdigitated capacitor structure according to the prior art.

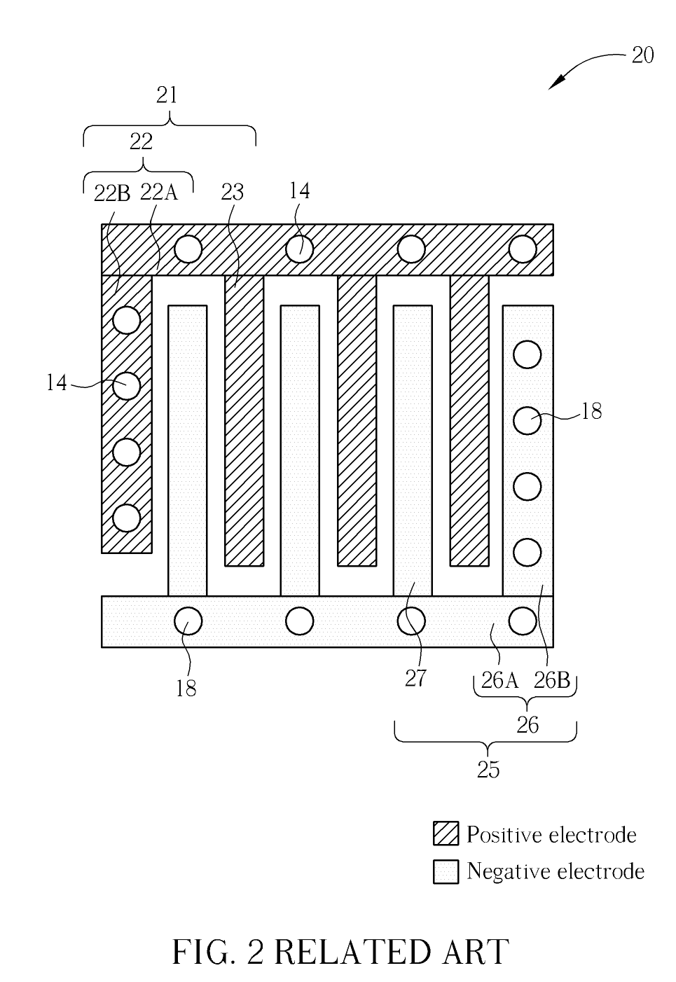

FIG. 3 is a simplified diagram of a first metal layer of a capacitor structure according to a first embodiment of the present invention.

FIG. 4 is a simplified diagram of a second metal layer of the capacitor structure according to the first embodiment of the present invention.

FIG. 5 is a simplified diagram showing the first metal layer shown in FIG. 3 superimposed on top of the second metal layer shown in FIG. 4 in the capacitor structure according to the first embodiment of the present invention.

FIG. 6 is a simplified diagram showing a plurality of the first metal layers shown in FIG. 3 stacked with each other and a third metal layer superimposed on top of a top side first metal layer in a capacitor structure according to a second embodiment of the present invention.

FIG. 7 is a simplified diagram showing the plurality of first via plugs and the plurality of second via plugs having a larger cross-section size in the capacitor structure according to the second embodiment of the present invention.

FIG. 8 is a simplified diagram showing the plurality of first via plugs and the plurality of second via plugs having the same cross-section size as the plurality of first strips in the capacitor structure according to the second embodiment of the present invention.

FIG. 9 is a simplified diagram showing other metal layer layout contour for the capacitor structure in the present invention.

FIG. 10 is a simplified diagram showing other metal layer layout contour for the capacitor structure in the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections. In addition, the term “strip” or “strips” used in the present invention can be any elongated shape.

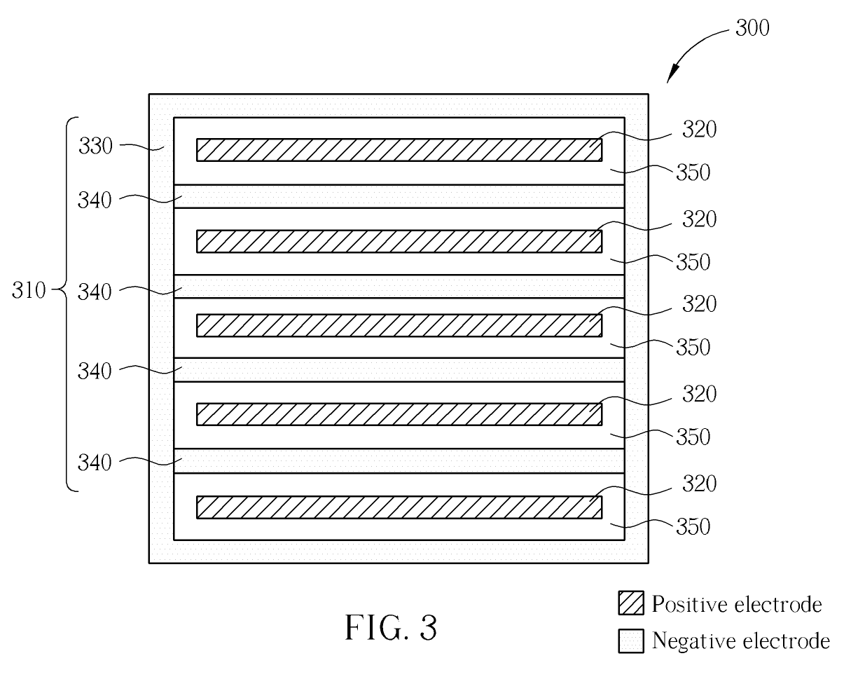

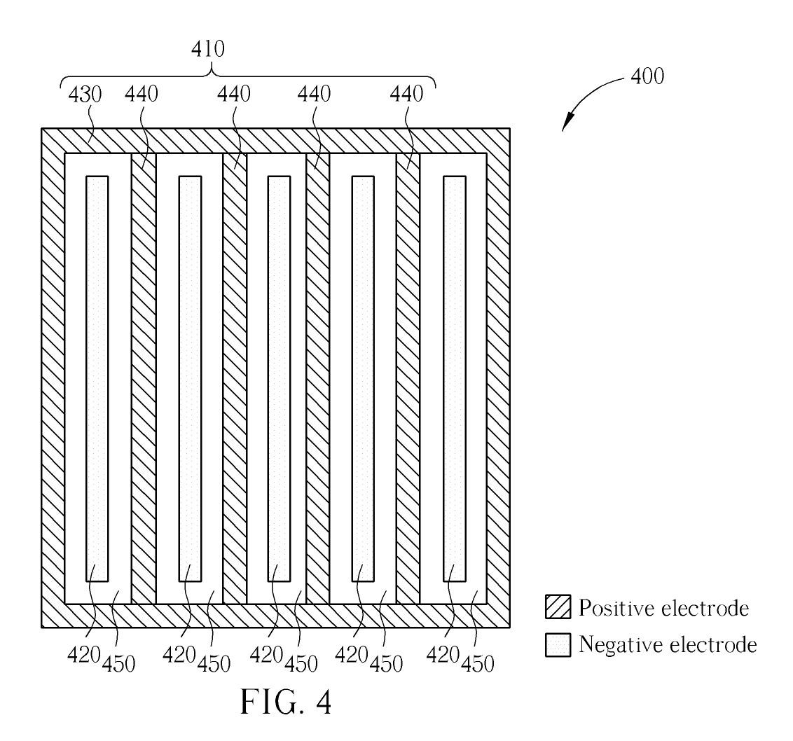

Please refer to FIG. 3 and FIG. 4 at the same time. FIG. 3 is a simplified diagram of a first metal layer 300 of a capacitor structure according to a first embodiment of the present invention, and FIG. 4 is a simplified diagram of a second metal layer 400 of the capacitor structure according to the first embodiment of the present invention. In general, the capacitor structure according to the first embodiment of the present invention is made up by interlacing and stacking a plurality of the first metal layers 300 shown in FIG. 3 and a plurality of the second metal layers 400 shown in FIG. 4. In other words, a second metal layer 400 is superimposed on top of a first metal layer 300, and another first metal layer 300 is further superimposed on top of the second metal layer 400, and this scheme continues in the same way in order to make up the capacitor structure by interlacing and stacking a plurality of the first metal layers 300 and a plurality of the second metal layers 400. In addition, there can be an oxide layer as a dielectric layer between each of the first metal layers 300 and the adjacent second metal layers 400, since the capacitor structure in the first embodiment can be a metal-oxide-metal (MOM) capacitor structure. It should be noted that the materials used in the first metal layer 300 and the second metal layer 400 can be aluminum, copper, gold, or other kinds of metal materials or nonmetal materials according to different semiconductor manufacturing processes.

As shown in FIG. 3, the first metal layer 300 includes a first frame structure 310 and a plurality of first strips 320, wherein the first frame structure 310 and the plurality of first strips 320 make up two electrodes of the capacitor structure in the first embodiment. For example, the first frame structure 310 can make up a negative electrode (or a positive electrode) of the capacitor structure, and the plurality of first strips 320 can make up a positive electrode (or a negative electrode) of the capacitor structure. In addition, the first frame structure 310 includes a first main frame 330 and a plurality of first frame strips 340 electrically connected to the first main frame 330, wherein the plurality of first frame strips 340 are utilized for separating the first main frame 330 to a plurality of first frame sections 350, and each of the plurality of first strips 320 is positioned and isolated in one of the plurality of first frame sections 350.

As shown in FIG. 4, the second metal layer 400 includes a second frame structure 410 and a plurality of second strips 420, wherein the second frame structure 410 and the plurality of second strips 420 respectively make up two electrodes of the capacitor structure in the first embodiment. For example, the second frame structure 410 can make up a negative electrode (or a positive electrode) of the capacitor structure, and the plurality of second strips 420 can make up a positive electrode (or a negative electrode) of the capacitor structure. In addition, the second frame structure 410 includes a second main frame 430 and a plurality of second frame strips 440 electrically connected to the second main frame 430, wherein the plurality of second frame strips 440 are utilized for separating the second main frame 430 to a plurality of second frame sections 450, and each of the plurality of second strips 420 is positioned and isolated in one of the plurality of second frame sections 450.

In the first embodiment, the plurality of first strips 320, the plurality of second frame strips 440 and the second main frame 430 make up a part of a positive electrode of the capacitor structure, and the plurality of second strips 420, the plurality of first frame strips 340 and the first main frame 330 make up a part of a negative electrode of the capacitor structure. However, this is only for an illustration purpose and is not meant to be a limitation of the present invention. For example, the plurality of first strips 320, the plurality of second frame strips 440 and the second main frame 430 also can make up a part of a negative electrode of the capacitor structure, and the plurality of second strips 420, the plurality of first frame strips 340 and the first main frame 330 also can make up a part of a positive electrode of the capacitor structure in another embodiment of the present invention.

In the first embodiment, the first metal layer 300 and the second metal layer 400 are identical in size. In addition, the plurality of first strips 320 are parallel to the plurality of first frame strips 340, the plurality of second strips 420 are parallel to the plurality of second frame strips 440, and the first main frame 330 and the second main frame 430 are both rectangular. The plurality of first frame sections 350 are parallel to each other, the plurality of second frame sections 450 are parallel to each other, and the plurality of first frame sections 350 and the plurality of second frame sections 450 are all rectangular. This is, however, only for illustration purposes and is not meant to be a limitation of the present invention. For example, both the first main frame 330 and the second main frame 430 can also be square, parallel quadrilateral or of any polygonal shapes, and all of the plurality of first frame sections 350 and the plurality of second frame sections 450 can also be square, parallel quadrilateral or of any polygonal shapes accordingly in the other embodiments of the present invention.

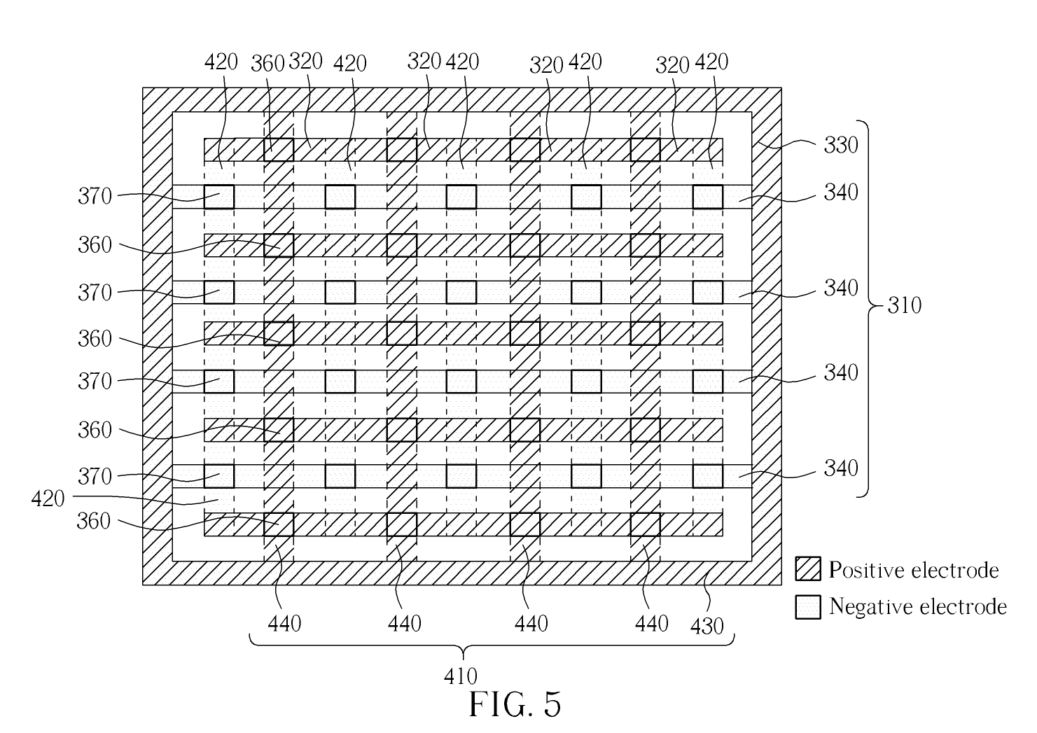

Please refer to FIG. 5. FIG. 5 is a simplified diagram showing the first metal layer 300 shown in FIG. 3 superimposed on top of the second metal layer 400 shown in FIG. 4 in the capacitor structure according to the first embodiment of the present invention. As shown in FIG. 5, the plurality of first strips 320 and the plurality of first frame strips 340 in the first metal layer 300 are interlaced with the plurality of second strips 420 and the plurality of second frame strips 440 in the second metal layer 400 at 90 degrees on the same plane. In addition, the capacitor structure further includes a plurality of first via plugs 360 and a plurality of second via plugs 370, wherein the plurality of first via plugs 360 are utilized for electrically connecting the plurality of first strips 320 to the plurality of second frame strips 440, and the plurality of second via plugs 370 are utilized for electrically connecting the plurality of second strips 420 to the plurality of first frame strips 340. Herein please note that cross-sections of the plurality of first via plugs 360 and the plurality of second via plugs 370 on a plane parallel to the first metal layer 300 and the second metal layer 400 are all rectangular in the first embodiment. This is only for illustration purposes, however, and is not meant to be a limitation of the present invention. For example, the cross-sections of the plurality of first via plugs 360 and the plurality of second via plugs 370 on the plane parallel to the first metal layer 300 and the second metal layer 400 also can be all square, parallel quadrilateral or of any polygonal shapes according to varying layout and design requirements.

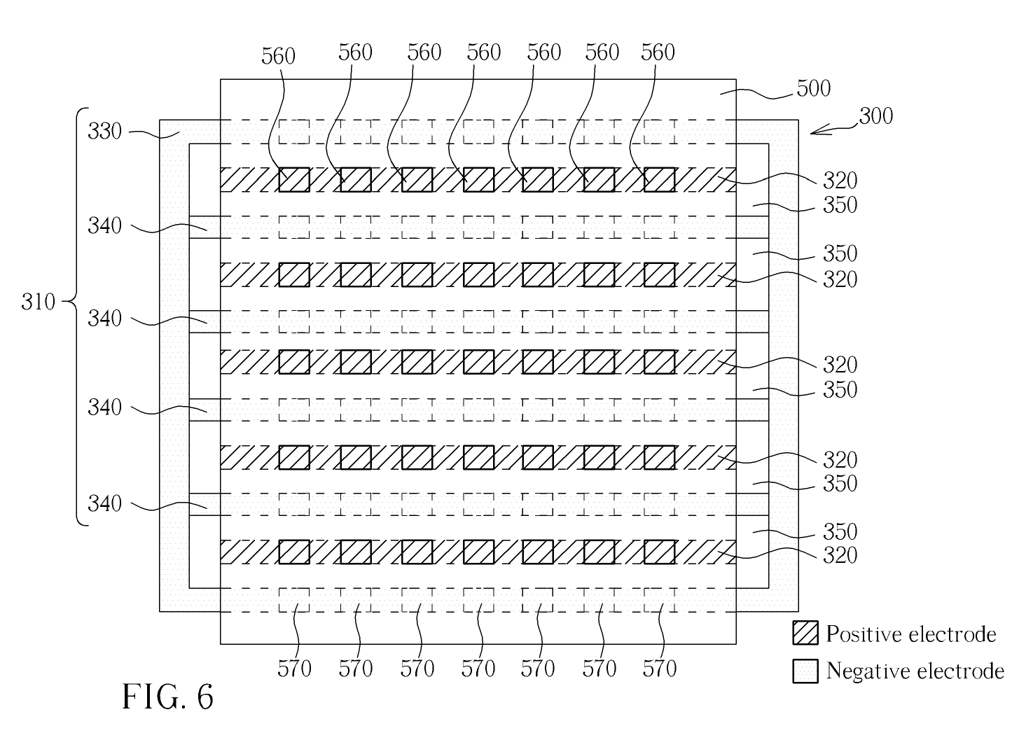

Please refer to FIG. 6 and recall FIG. 3 at the same time. FIG. 6 is a simplified diagram showing a plurality of the first metal layers 300 shown in FIG. 3 stacked with each other and a third metal layer 500 superimposed on top of a top side first metal layer 300 in a capacitor structure according to a second embodiment of the present invention. In other words, the main metal layers of the capacitor structure in the second embodiment have identical layouts, identical electrode distribution, and are identical in size. Similar to the first embodiment of the present invention, there can also be an oxide layer as a dielectric layer between the adjacent first metal layers 300, and between the third metal layer 500 and the top side first metal layer 300, since the capacitor structure in the second embodiment can also be the metal-oxide-metal (MOM) capacitor structure. Because configuration details related to the first metal layer 300 are all well illustrated in the above paragraphs, further explanation of the configuration details of the first metal layer 300 is omitted herein for the sake of brevity.

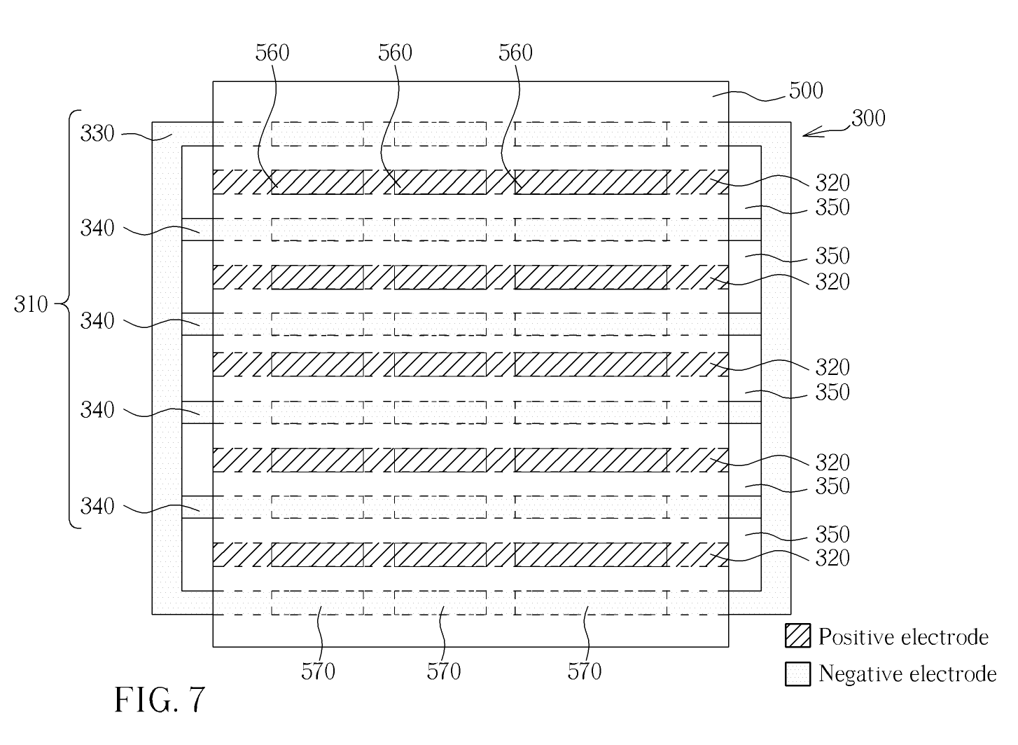

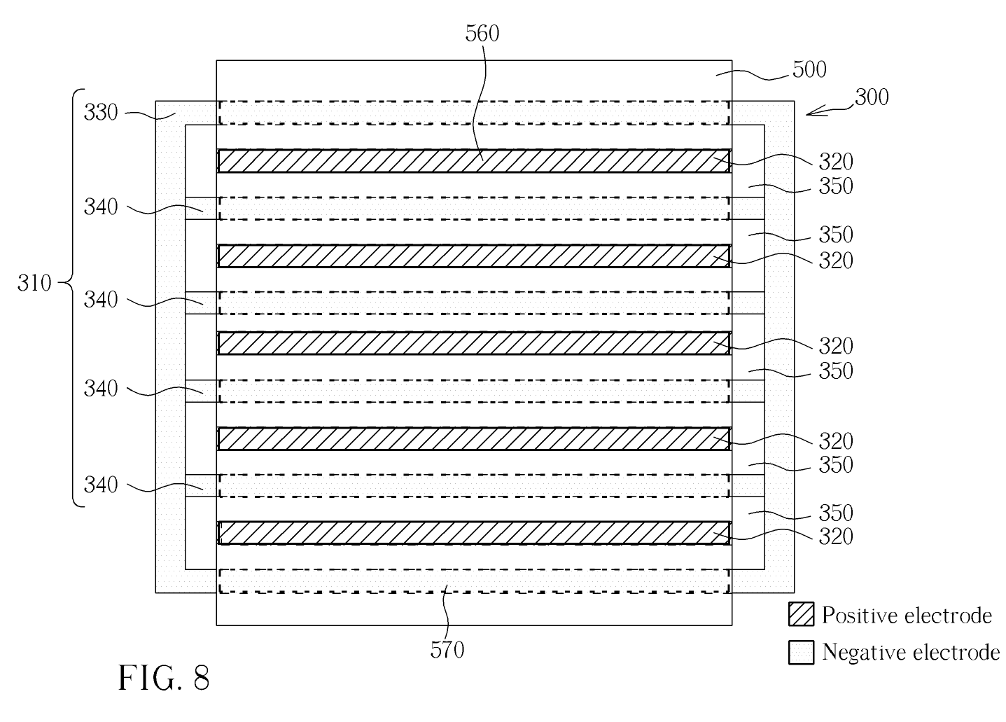

In the second embodiment, the capacitor structure further includes a plurality of first via plugs 560 and a plurality of second via plugs 570, wherein the plurality of first via plugs 560 are utilized for electrically connecting all of the plurality of first strips 320 of the plurality of first metal layers 300 to the third metal layer 500, and the plurality of second via plugs 570 are utilized for electrically connecting the plurality of first frame strips 340 and the first main frame 330 between each of the plurality of first metal layers 300. The plurality of first strips 320 and the third metal layer 500 make up a part of a positive electrode of the capacitor structure. The plurality of first frame strips 340 and the first main frame 330 make up a part of a negative electrode of the capacitor structure. Herein please note that cross-sections of the plurality of first via plugs 560 and the plurality of second via plugs 570 on a plane parallel to the plurality of first metal layers 300 are all rectangular in the second embodiment. In addition, the third metal layer 500 is utilized for electrically connecting all of the plurality of first strips 320 of the plurality of first metal layers 300 to, for example, an electrode outside the capacitor structure. However, this is only for illustration purposes and is not meant to be a limitation of the present invention. For example, the cross-sections of the plurality of first via plugs 560 and the plurality of second via plugs 570 on the plane parallel to the plurality of first metal layers 300 also can be all square, parallel quadrilateral, bar-like or of any polygonal shapes according to different layout and design requirements. Please refer to FIG. 7 and FIG. 8. FIG. 7 is a simplified diagram showing the plurality of first via plugs 560 and the plurality of second via plugs 570 having a larger cross-section size in the capacitor structure according to the second embodiment of the present invention. FIG. 8 is a simplified diagram showing the plurality of first via plugs 560 and the plurality of second via plugs 570 having the same cross-section size as the plurality of first strips 320 in the capacitor structure according to the second embodiment of the present invention.

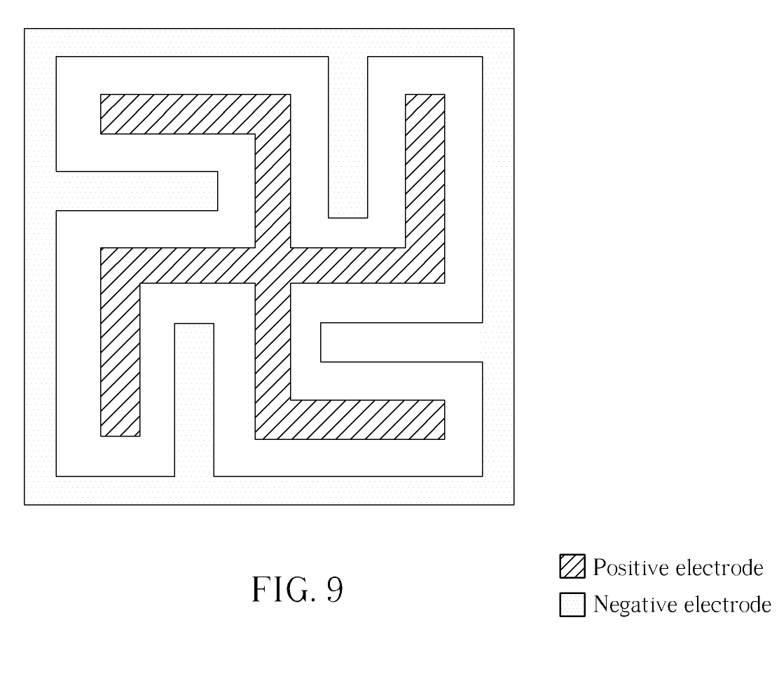

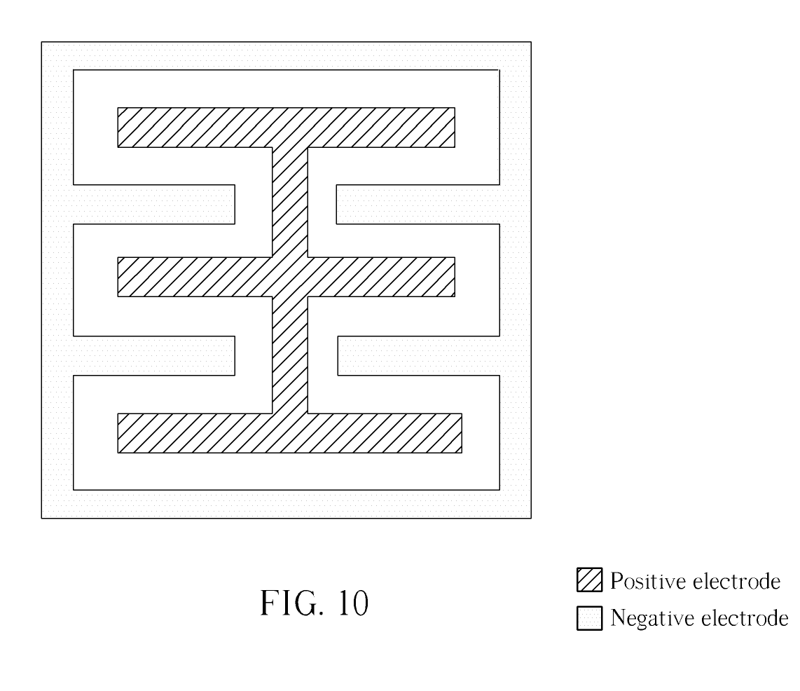

Please note that the embodiments mentioned above are presented only for illustrating the present invention, and in no way should be considered to be limitations of the scope of the present invention. All kinds of the metal layer layout contour can be applied to the capacitor structure in the present invention. For example, please refer to FIG. 9 and FIG. 10. FIG. 9 and FIG. 10 are simplified diagrams showing other metal layer layout contours for the capacitor structure in the present invention.

Briefly summarized, since the plurality of via plugs are uniformly distributed in the plurality of metal layers for forming the electrical connection and since the cross-sections of the plurality of via plugs on the plane parallel to the plurality of metal layers can be designed to have the maximum square area according to the different patterns of the metal layer layout, the capacitor structure disclosed in the present invention is able to attain a greater unit capacitance. In addition, the abovementioned main frames of the capacitor structure in the present invention can provide an additional shielding effect to attain improved electrical performance for the capacitor structure in the present invention. In addition, due to the semiconductor process improvement, a quite large amount of metal layers can be stacked in the capacitor structure disclosed by the present invention, and thus the unit capacitance of the capacitor structure becomes higher.

Those skilled in the art will readily observe that numerous modifications and alterations of the device and method may be made while retaining the teachings of the invention.

What is claimed is:

1. A capacitor structure, comprising:
a first metal layer, comprising:
a first frame structure; and
a first strip, positioned and isolated in the first frame structure;
a second metal layer, comprising:
a second frame structure; and
a second strip, positioned and isolated in the second frame structure; and
a dielectric layer, formed between the first metal layer and the second metal layer.

2. The capacitor structure of claim 1, wherein the first frame structure comprises a first main frame and at least a first frame strip coupled to the first main frame for separating the first main frame to a plurality of first frame sections; the first metal layer comprises a plurality of first strips, each of the plurality of first strips positioned and isolated in one of the plurality of first frame sections; the second metal layer comprises a second main frame and at least a second frame strip coupled to the second main frame for separating the second main frame to a plurality of second frame sections; and the second metal layer comprises a plurality of second strips, each of the plurality of second strips positioned and isolated in one of the plurality of second frame sections.

3. The capacitor structure of claim 2, further comprising:
a plurality of first via plugs, for electrically connecting the plurality of first strips to the second frame strip; and
a plurality of second via plugs, for electrically connecting the plurality of second strips to the first frame strip.

4. The capacitor structure of claim 3, wherein the plurality of first strips, the second frame strip and the second main frame make up a part of a positive electrode of the capacitor structure, and the plurality of second strips, the first frame strip and the first main frame make up a part of a negative electrode of the capacitor structure.

5. The capacitor structure of claim 3, wherein the plurality of first strips, the second frame strips and the second main frame make up a part of a negative electrode of the capacitor structure, and the plurality of second strips, the first frame strip and the first main frame make up a part of a positive electrode of the capacitor structure.

6. The capacitor structure of claim 3, wherein the plurality of first strips are parallel to the first frame strip, the plurality of second strips are parallel to the second frame strip, the first main frame and the second main frame are both polygonal.

7. The capacitor structure of claim 6, wherein cross-sections of the plurality of first via plugs and the plurality of second via plugs on a plane parallel to the first metal layer and the second metal layer are polygonal.

8. The capacitor structure of claim 2, further comprising:
a plurality of first via plugs, for electrically connecting the plurality of first strips to the plurality of second strips; and
a plurality of second via plugs, for electrically connecting the first frame strip and the second frame strip.

9. The capacitor structure of claim 8, wherein the plurality of first strips and the plurality of second strips make up a part of a positive electrode of the capacitor structure, and the first frame strip, the first main frame, the second frame strip and the second main frame make up a part of a negative electrode of the capacitor structure.

10. The capacitor structure of claim 8, wherein the plurality of first strips and the plurality of second strips make up a part of a negative electrode of the capacitor structure, and the first frame strip, the first main frame, the second frame strip and the second main frame make up a part of a positive electrode of the capacitor structure.

11. The capacitor structure of claim 8, wherein the plurality of first strips are parallel to the first frame strip, the plurality of second strips are parallel to the second frame strip, the first main frame and the second main frame are both polygonal.

12. The capacitor structure of claim 11, wherein cross-sections of the plurality of first via plugs and the plurality of second via plugs on a plane parallel to the first metal layer and the second metal layer are polygonal or bar-like.

13. The capacitor structure of claim 8, further comprising:
a third metal layer, electrically connected to the plurality of first strips and the plurality of second strips via the plurality of first via plugs, for electrically connecting the plurality of first strips and the plurality of second strips to at least an electrode outside the capacitor structure.

14. The capacitor structure of claim 2, wherein the plurality of first strips and the first frame strip are interlaced with the plurality of second strips and the second frame strip at 90 degrees on a same plane.

15. The capacitor structure of claim 2, wherein the first metal layer and the second metal layer have an identical layout, an identical electrode distribution, and an identical size.

16. The capacitor structure of claim 1, being a metal-oxide-metal (MOM) capacitor structure.

17. The capacitor structure of claim 1, further comprising:
at least a first via plug, for electrically connecting the first strip to the second strip; and
at least a second via plug, for electrically connecting the first frame structure to the second frame structure.

18. The capacitor structure of claim 17, wherein the first strip and the second strip make up a part of a positive electrode of the capacitor structure, and the first frame structure and the second frame structure make up a part of a negative electrode of the capacitor structure.

19. The capacitor structure of claim 17, wherein the first strip and the second strip make up a part of a negative electrode of the capacitor structure, and the first frame structure and the second frame structure make up a part of a positive electrode of the capacitor structure.

20. The capacitor structure of claim 17, wherein the first main frame and the second main frame are both polygonal.

21. The capacitor structure of claim 20, wherein a cross-section of the via plug on a plane parallel to the first metal layer and the second metal layer is polygonal or bar-like.

22. A metal layer layout for a capacitor structure, the metal layer layout comprising:
a metal layer, comprising:
a frame structure; and
at least a strip, positioned and isolated in the frame structure.

23. The metal layer layout of claim 22, wherein the frame structure comprises a main frame and at least a frame strip coupled to the main frame for separating the main frame to a plurality of frame sections; and the metal layer comprises a plurality of strips, each of the plurality of strips positioned and isolated in one of the plurality of frame sections.

24. The metal layer layout of claim 23, wherein the plurality of strips are parallel to the frame strip, the main frame structure is polygonal.

25. The metal layer layout of claim 22, wherein a material of the metal layer is aluminum, copper, or gold.
